(19) United States
(12) Patent Application Publication
(10) Pub. No.: US 2005/0213992 A1
(43) Pub. Date: Sep. 29, 2005

(54) Method and apparatus for optical transmission of data

(76) Inventor: David M. Piehler, Half Moon Bay, CA (US)

Correspondence Address: MORRISON & FOERSTER LLP, 755 PAGE MILL RD, PALO ALTO, CA, 94304-1018, US

(21) Appl. No.: 10/810,200

(22) Filed: Mar. 25, 2004

(51) Int. Cl. H04B 10/04

(52) U.S. Cl. 398/198

(57) ABSTRACT

Method and apparatus for optical communications. An apparatus for optical communication includes the functionality of both a modulator and an optical transmitter. The modulator receives video data, typically in the digital data form, in the electrical or optical domain and converts it into suitable RF (radio frequency) signals which are then used to modulate a conventional optical (laser) transmitter. The optical transmitter outputs, on optical fiber, a suitable light signal for use in an optical communications network, for instance a cable TV or fiber to the premises system. The modulator and optical transmitter are included in a single apparatus and have a shared controller (e.g., microprocessor or microcontroller) which is suitable programmed so as to allow installation, set up and calibration jointly of the modulator and optical transmitter. Thereby installation/set up/calibration is accomplished more efficiently than if the modulator and optical transmitter were independently calibrated or tuned. By using a common controller and common user interface, intelligence in the controller can set operating parameters of both the modulator and the optical transmitter in some cases via closed loop operation thus substantially simplifying and reducing costs of installation.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO A COMPACT DISK APPENDIX

Not applicable.

### FIELD OF THE INVENTION

This disclosure pertains to optical communications.

### BACKGROUND OF THE INVENTION

Optical communications are well known, one particular application being cable television. In many cable television systems, the transmission is a hybrid of transmission in the RF (radio frequency) domain and in the optical domain. The RF type (electrical) signals are typically carried on coaxial cable and the optical signals on optical fiber. For instance, the signals may be transmitted from the head end in the form of RF or data signals of the type used in computer networking which are then converted into optical signals to be transmitted along optical fiber cable to a receiver. Fiber optic networks are the information backbone upon which many network (e.g., cable television) operators deliver broadband interactive services such as high speed internet access, telephony, video and audio streaming and video on demand. There are other well known hybrid optical fiber/coaxial cable networks providing ultimately an electrical signal on the coaxial cable to the home. There is also what is referred to as “fiber to the home” or “fiber to the premises” networks in which the optical fibers extend all the way to the home or business receiver of the subscriber to the network.

Typically such systems include a component referred to here as a “modulator” which extracts video information from the digital signal input and converts it into a radio frequency signal suitable to modulate a laser. Typically the laser is provided in a second component generally referred to herein as an optical transmitter which outputs suitable optical signals onto an optical fiber for communication.

An example of such a modulator (also referred to as an “edge QAM” in the field) manufactured and sold by Harmonic Inc. is the “Narrowcast Services Gateway” product. These modulators typically receive standard GbE (Gigabit Ethernet), ASI (asynchronous serial interface) or similar digital electrical (or optical) signals and convert them to radio frequency signals suitable for modulating a laser by using QAM modulators. Typically the input signals contain MPEG-2 data. The modulator typically outputs a radio frequency signal such as a QAM (Quadrature Amplitude Modulated) RF or ASI signal up converted onto an RF carrier signal, as is standard in the field.

An example of an optical transmitter (also referred to as a “transmitter” in the field) is a product also manufactured and sold by Harmonic Inc. referred to as the HLD MetroLink™ Forward Path Transmitter. This product includes a distributed feedback laser (DFB) and associated components. The laser output optical signal is one of typically 32 wavelengths as defined by the International Telecommunication Union (ITU). This product uses dense wavelength division multiplexing (DWDM), and allows provision of targeted digital “narrowcast” (i.e., to a distinct group of customers) transmissions on a single optical fiber.

Each of these products, as is typical of those in the field, has its own user (operator) interface. For instance the above described NSG modulator is microprocessor controllable locally or remotely through a variety of user protocols including SNMP (simple network management protocol) XML, HTTP, etc. The MetroLink forward path transmitter similarly includes its own microprocessor for control of key operating parameters to provide consistent and optimum performance and monitoring. Both of these products must be independently set up and calibrated via the user interface when installed. Exemplary parameters to be controlled for the modulator include the number of radio frequency channels (each of which is typically one channel of cable television), a choice of modulation for instance 64 or 256 QAM for each channel, the radio frequency and/or bandwidth of each RF channel, and RF channel output power level. Similarly the parameters to be controlled for the optical transmitter include the amount of RF attenuation (pad), the optical modulation index (OMI) and the optical output power. Since these two products work closely together and typically are serially coupled by a coaxial cable, it is important for the various parameters to be calibrated in a coordinated fashion. Typically this calibration is carried out by a technician when the products are installed in a network. This calibration is relatively expensive and complex and must be accomplished in the field. This cost and difficulty of installation and set up is recognized in the industry as being a drawback, but to date no solutions have been proposed since typically the above mentioned devices are sold as individual components each with its own enclosure, power supply, and user interface.

FIG. 1A shows an example of a prior art system of the type referred to above, all of whose components are conventional. A video server 10, typically maintained at a cable television system head-end, transmits on either copper cable or optical fiber 12 Gigabit Ethernet type signals, typically of the video on demand (VOD) type referred to also as “narrowcast”. These signals are received by the modulator 14 here designated “edge QAM” which has a second GbE interface such that multiple edge QAMs may be “daisy-chained” as is typical in the field. Cable 16 carries data signals. The modulator 14 then transmits the received signals, still in the electrical domain but now in QAM form, to a radio frequency network 18 which in turn is connected via attenuator 20 to a combiner 24. The broadcast television content (also in RF) is applied at input port 28. The combined RF signals are then applied to modulate an optical transmitter 26 in this case operating at 1310 nanometers wavelength which is a conventional optical transmitter of the type made and sold by Harmonic Inc. known as the PWR Link directly modulated 1310 nm transmitter. This in turn propagates the optical signal on optical fiber 30 ultimately to the end user.

Another version of this system is shown in FIG. 1B with similar elements identically labeled and having a slightly different optical transmitter 32 here operating in the 1550 to 1560 nanometer wavelength bandwidth. Also provided in the lower portion of FIG. 1B is an external modulated video optical transmitter 42 which is also of the type described above which receives the broadcast television signal content on input port 44 and propagates this in optical form along optical fiber 50 to the EDFA (erbium doped fiber amplifier) 52 which turn is connected to an optical splitter 54, one output port of which is connected to a wavelength division multiplexer (WDM) 36. The narrowcast optical signal from optical transmitter 32 is connected via optical variable attenuator 34 to a second input port of WDM 36. In this case a second EDFA 38 is connected between the WDM 36 and the output optical fiber 30.

### SUMMARY

Disclosed here is a combination modulator and optical transmitter capable of receiving input digital data (optical or electrical) signals such as those conforming to Ethernet or other standards and outputting optical signals suitable for propagation on an optical fiber. Hence this apparatus accomplishes both modulating the input digital data signal into a radio frequency signal and using that radio frequency signal to drive a laser outputting the optical signal. In addition to typically being housed in a common enclosure, the modulator and optical transmitter are controlled by a single controller (for instance a microprocessor or microcontroller) having a single user interface, for instance of the SNMP type. This has the significant advantage of not only reducing component count, for instance by having only one power supply and one controller, but also advantageously having a single user interface for setting up and calibrating the apparatus. The interface employs a process to determine the operating parameters of both the modulator and the optical transmitter without requiring independent parameters to be input for each, as done in the prior art. Thus a suitable process is provided, for instance in the form of a computer program executed by the controller, to determine the operating parameters for both the modulator and optical transmitter depending on a single set of user inputs for set up and calibration of the combined modulator and optical transmitter. Hence the controller adjusts the modulator and optical transmitter operating parameters for optimal performance. Thus the single controller and user interface allow significant cost improvements in terms of both hardware components and even more importantly set up and calibration time, thereby reducing the cost of installing an optical communications network.

### BRIEF DESCRIPTION OF THE DRAWINGS

FIGS. 1A, 1B show prior art systems;

FIG. 2 shows a system in accordance with this disclosure;

FIGS. 2-7 show variants of the FIG. 2 system;

FIG. 8 shows in a flowchart a process to install and control the systems of FIGS. 2-7.

### DETAILED DESCRIPTION

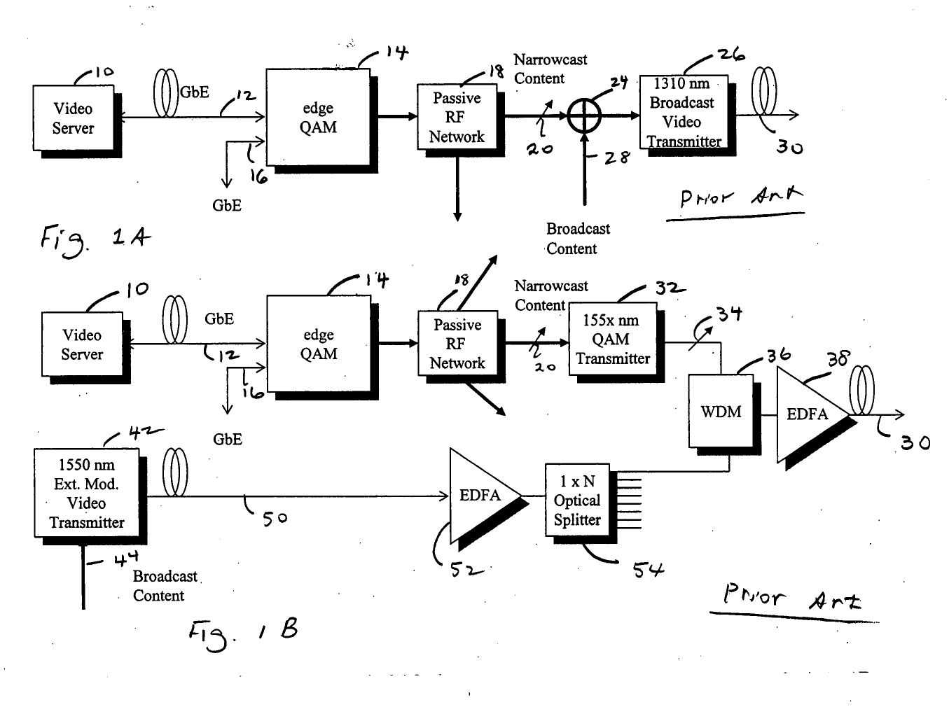

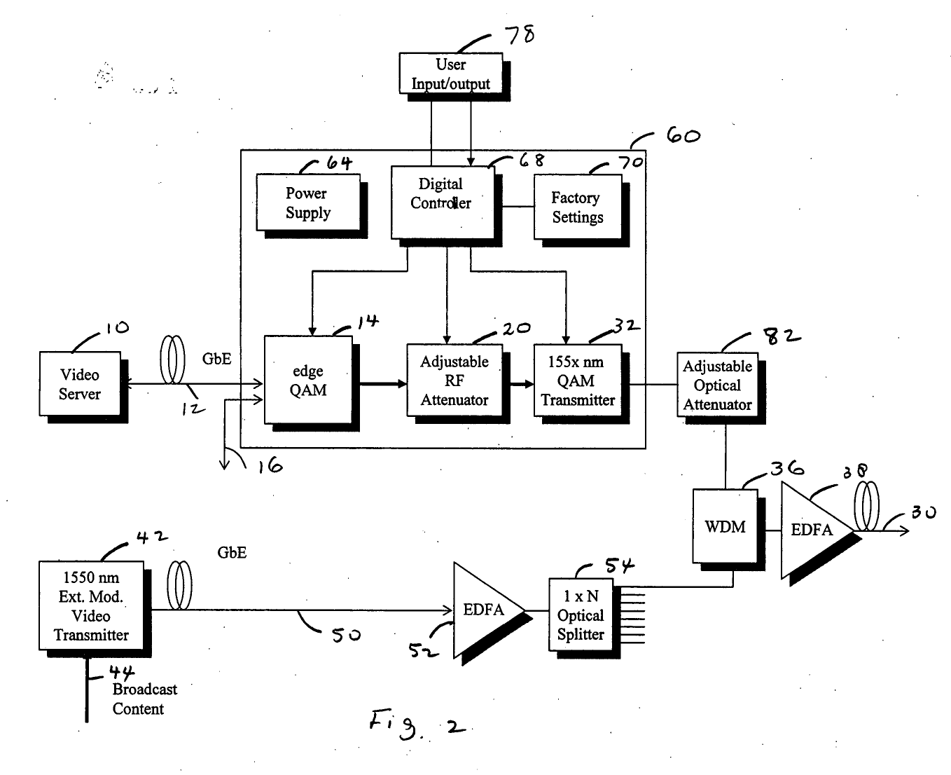

FIG. 2 shows in a block diagram a system in accordance with this disclosure which has a number of elements identical to those of FIG. 1B, and which are similarly labeled. In FIG. 2 modulator 14 and optical transmitter 32 may be included in a single housing which may be provided at the factory or installed in the field. Modulator 14 and transmitter 32 share a single digital controller 68. Controller 68 is typically a conventional circuit board including a microprocessor/microcontroller and associated support circuitry for purposes of control of modulator 14 and transmitter 32 jointly. Controller 68 has a conventional user input/output interface 78 which is typically a connection to an external computer located either locally or remotely. Typically when the computer is provided locally it is only connected temporarily for purposes of calibration/set up of apparatus 60.

In the prior art, e.g. FIGS. 1A and 1B, there are also user input/output interfaces for modulator 14 and transmitter 32 but there each of 14 and 32 has its own individual controller and individual user interface, unlike the shared or common user interface and controller of FIG. 2. Also typically in the prior art there is no such single apparatus 60 as shown in FIG. 2, but devices 14 and 32 are typically sold separately and may in the field be installed in a common housing but are not so assembled at the factory. Additionally shown in FIG. 2 is a set of initial (factory) settings 70 provided e.g. at the factory for initially setting up digital controller 68. The only other element of FIG. 2 not present in the earlier figures is the adjustable optical attenuator 82 external to apparatus 60; this is a conventional component.

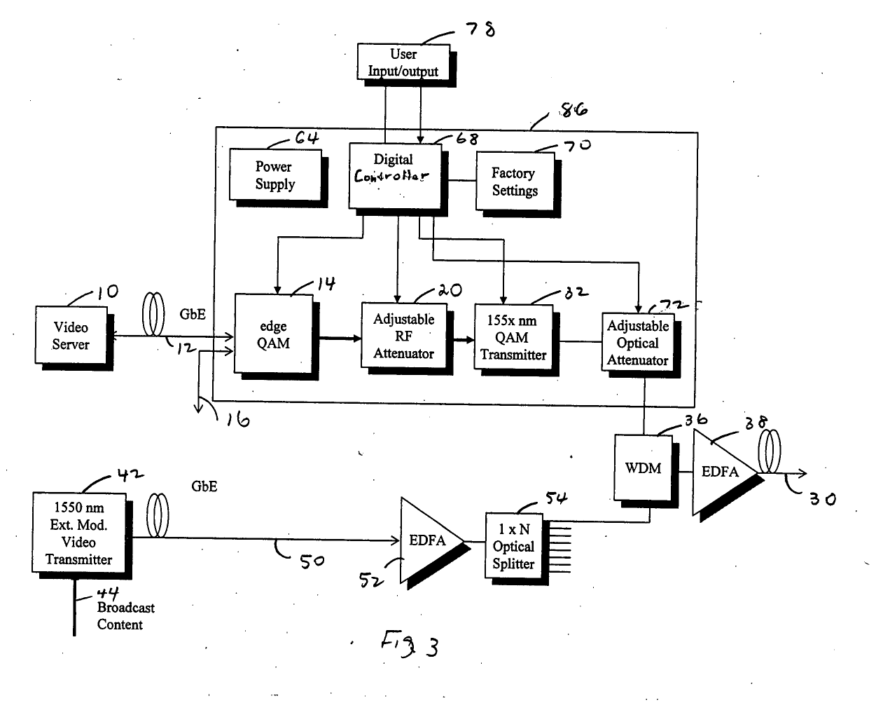

FIG. 3 shows a system with many similar elements to that of FIG. 2 and similarly labeled again having the common digital controller 68 and user input/output interface 78. In this case the adjustable optical attenuator 72 is included within the apparatus 86 rather than external thereto as in FIG. 2. The attenuator 72 is similarly controlled in conjunction with the modulator and transmitter.

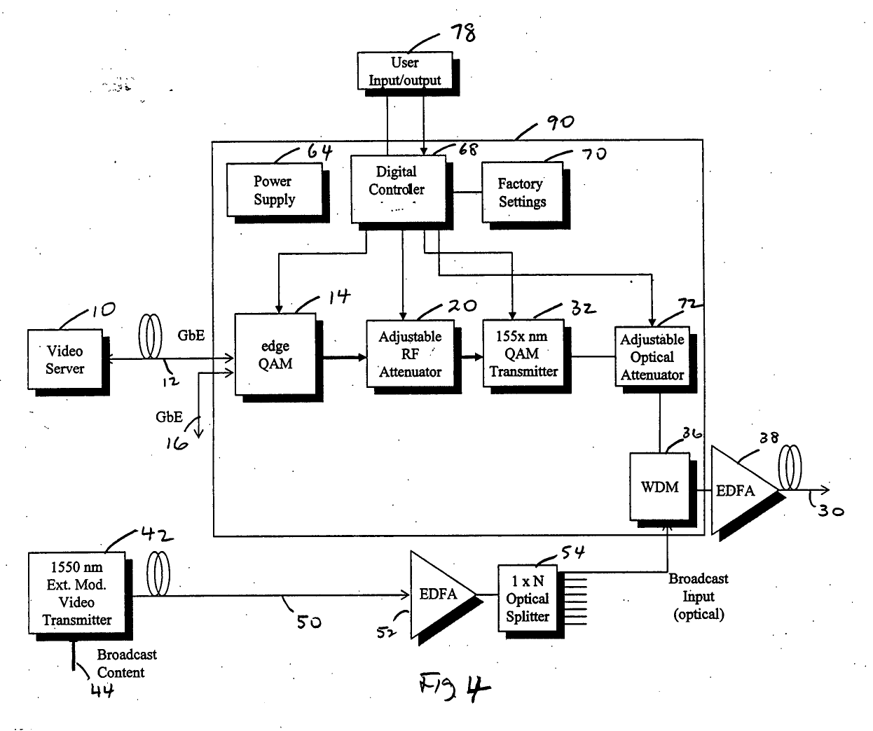

FIG. 4 shows a system in many ways similar to that of FIG. 3 but including the WDM 36 within apparatus 90.

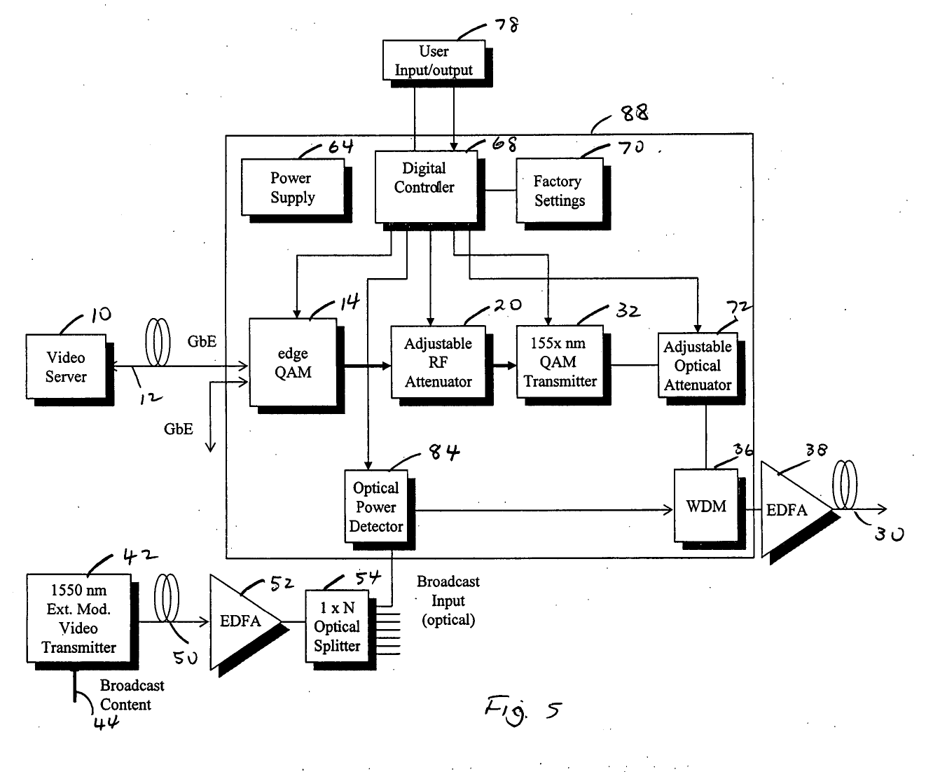

FIG. 5 shows yet another system in most respects similar to that of FIG. 4 but further including in apparatus 88 a conventional optical power detector 84 coupled between digital controller 68 and WDM 36 for purposes of conventionally controlling parameters of the modulator, transmitter and optical attenuator as described below.

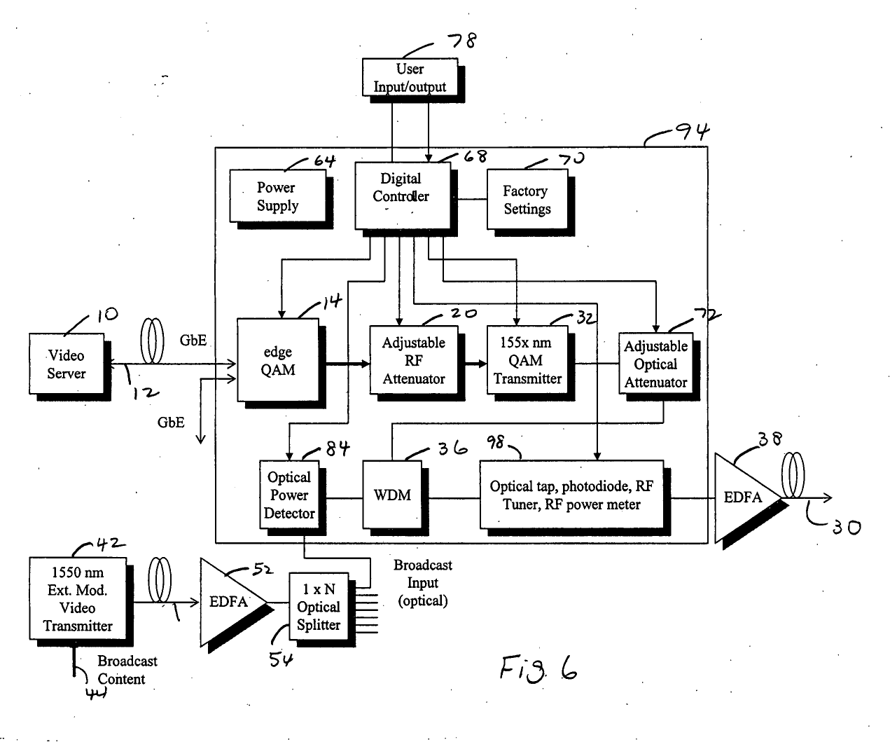

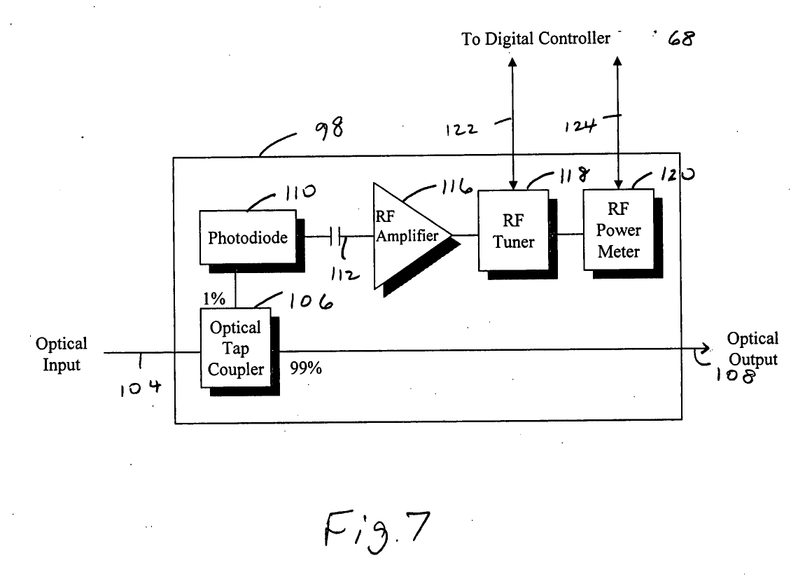

FIG. 6 shows another variant of the system where apparatus 94 in addition to the various components similarly connected as in FIG. 5 also includes further control circuitry 98 in the optical path for closed loop (i.e., feedback) control purposes. Detail of control circuit 98 is shown in FIG. 7 showing the optical signal input on optical fiber 104 from WDM 36 is connected to an optical tap coupler 106 which propagates 99% of the signal strength to the optical output fiber 108 which connects to the EDFA 38 (not shown) of FIG. 6.

The additional control elements shown in FIG. 7 include photodiode 110, filter capacitor 112, RF amplifier 116, RF tuner 118 and RF power meter 120. This FIG. 7 circuit provides a means of measuring the optical power since 1% of the optical power is diverted from the coupler 106 to photodiode 110. The RF tuner 118 and RF power meter 120 are connected via digital control lines respectively 122 and 124 to digital controller board 68 for RF and optical signal strength control purposes to create the closed control loop.

As pointed out above, typically user interface 78 is a connection to an external computer or computing device for providing the desired operating commands to determine the various operating parameters. A technician typically receives information provided by interface 78 for field adjustment of for instance apparatus 60 of FIG. 2. User interface 78 may be one of several types. One type is an interface compatible with the SNMP (simplified network management protocol) interface well known in the field. Other types of user interfaces are also suitable. Note that in the apparatus 60, a single power supply 64 is provided (by conventional connections, not shown) to power all elements in apparatus 60 and a similar shared power supply is provided in FIGS. 2-6.

Operation of controller 68 in FIGS. 2-6 in one embodiment is as follows. It is to be understood that this is illustrative and not limiting but illustrates that modulator 14 and optical transmitter 32 are to be controlled jointly so that control and especially set up and calibration of both components is substantially simplified. It is understood that components 14, 24 are not merely installed and used but instead typically require in the field set up and calibration. However the present inventor has determined that there are relationships between the signal processing in the RF realm and in the optical realm determined by the configuration of the apparatus and also by the nature of electrical and corresponding optical signals. These relationships allow a single set up and calibration which is simpler than performing these tasks separately.

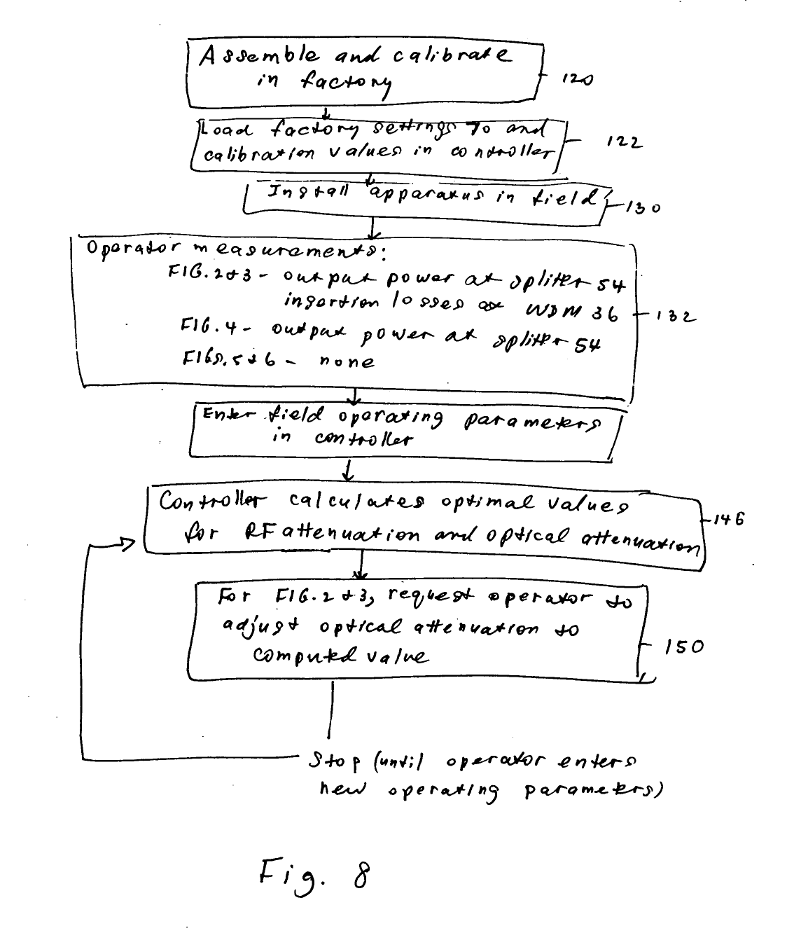

FIG. 8 shows a generalized flow chart for the process to install and control systems of the type shown in FIGS. 2-7 in accordance with the invention. Of course this is merely exemplary in terms of both the actual steps and also the particular operating parameters illustrated. Moreover, the various variables shown here of course are purely arbitrary but are the types suitable for use in a suitable computer program to be executed by a microprocessor/microcontroller present in controller 68.

In the first step 120, the apparatus, for instance apparatus 60 of FIG. 2, is assembled and calibrated in the factory by conventional methods. Next in step 122, still typically in the factory or at least prior to installation in the field, certain operating parameters or values (see detail below) for the optical transmitter 32 are set and loaded into the memory portion of controller 68. This corresponds to setting the factory settings 70 in FIG. 2.

In the next step 130, the apparatus, for instance 60, is actually installed in the system as shown in FIG. 2, in the field.

At step 132, the operator (technician) takes various optical power measurements, depending on the nature of the system. As shown, for FIGS. 2 and 3, he measures the output power at splitter 54 and insertion losses at WDM 36. For FIG. 4, he measures only the optical power at splitter 54. No such measurements are needed for FIGS. 5 and 6. These measurements are provided to controller 68 as optical measurement input values, see below.

In the next step at 134, certain operating parameters or values such as the number of RF channels and broadcast channels (explained in detail below) pertaining to modulator 14 and broadcast transmitter 42 are set in the field in the memory portion of controller 68 by the operator via the user interface 78.

At step 142, optical measurements pertaining to optical power are made within the apparatus while it is operating as detailed below.

In the next step 146, the controller 68 calculates certain output parameters for the RF attenuator 20 and optical attenuator 72, 82 using the formulas (pseudo-code) shown below, for calibration purposes.

In the last step 150, these calculated parameters and certain calibration instructions requesting the operator to adjust the optical attenuator 72, 82 (see FIGS. 2 and 3) to the computed value (see below) are displayed to the operator via user interface 78. The controller 68 then stops the calibration process until the operator enters a new operating parameter, when the process returns to step 146.

The following sets forth, in tabular form and pseudo-code expressed as algebraic formulas, the parameters relating to various factory settings 70 of step 122 and the field settings (not set at the factory) of step 134. These parameters and settings are collectively referred to below as “Input Values.” Also shown are the optical measurement values of step 132, and the calculated output parameters (“Output Values”) of step 146. The tables specify for each parameter/value an algebraic name, the physical unit, where it is set (factory or in the field), and whether that value is common or not for the entire broadcast region (spectrum.) The pseudo-code shows the algebraic relationships of the parameters and the accompanying narrative defines the subsequent activity by controller 68 per FIG. 8. This information is provided here for the systems of each of FIGS. 2 to 6, although there is a high degree of commonality.

1. FOR THE FIG. 2 SYSTEM

| | | | | Common value |
|---|---|---|---|---|
| | | | | for entire |
| | | | set at | Broadcast |
| | variable | units | factory? | region |
| INPUT VALUES | | | | |
| Input for Edge QAM 14 | | | | |
| #of RF channels (e.g. 1-30) | NncQAM | | NO | NO |
| bandwidth of RF channels (e.g. 6 or 8 MHz) | Be | MHz | NO | NO |
| # of RF channels with 256-QAM | Nnc256 | | NO | NO |
| modulation | | | | |
| #of RF channels with 64-QAM modulation | Nnc64 | | NO | NO |
| Input for Narrowcast Transmitter 32 | | | | |
| Optimum optical modulation index for 8 | mfactory | | YES | NO |
| channel loading (set at factory with 8 RF | | | | |
| QAM channels input channels | | | | |
| RF attenuator setting for such condition. | RFattFACTORY | dB | YES | NO |
| (set at factory) | | | | |
| Output power (set at factory) | Pncfactory | dBm | YES | NO |
| Input for Broadcast transmitter 42 | | | | |
| # of analog channels | Nanalog | | NO | YES |
| # of 256-QAM ch x dB below analog | Nbc256 | | NO | YES |
| | x | dB | NO | YES |
| # of 64-QAM ch y dB below analog | Nbc64 | | NO | YES |
| | y | dB | NO | YES |
| assumed OMI of transmitter = 3.6% | mbc | | default set | YES |
| | | | at 3.6% | |
| Optical measurement | | | | |
| Input optical power of broadcast wavelength | Pbc | | NO | NO |
| Insertion loss of WDM for Narrowcast | LncWDM | | NO | NO |
| wavelength | | | | |
| Insertion loss of WDM for Broadcast | LbcWDM | | NO | NO |
| wavelength | | | | |
| OUTPUT VALUES | | | | |
| adjustment for Ratt* | RFattSETTING | dB | Used for | |
| | | | internal | |
| | | | adjustment | |
| | | | of RF | |
| | | | attenuator | |
| optical attenuation for NC** | Opt Att | dB | Given to | |
| | | | operator | |

Calculate OMI per analog channel:
mANALOG=mbc*Sqrt[(6/Be)(80+33/4)/(Nanalog+Nbc256/10\hat{ }(x/10)+Nbc64/10\hat{ }(y/10)]
Calculate optical power and modulation index of the Narrowcast transmitter 32:
mNC256=mfactory*Sqrt[(6/Be)8/(Nnc256+Nnc64/10\hat{ }((y−x)/10))]
Then the power ratio of Narrowcast/Broadcast32 10 Log[mANALOG/mNC256 Sqrt[10\hat{ }(x/10)]]
The interface 78 then displays to the user (operator):
“The Narrowcast output should be attenuated by”
OptAtt=F2=10 Log[mANALOG/mNC256 Sqrt[10\hat{ }(x/10)]]+Pncfactory−Pbc−LncWDM+LbcWDM
The digital controller 68 then adjusts the value of RF attenuator 20 from the value of RFattFACTORY to:
RFattSETTING=Fl=−20*log[mANALOG/mNC256]+Rfattfactory
The digital controller 68 then monitors the changes made to the following parameters by the user:
NncQAM, Be, Nnc256, Nnc64, and adjusts the value of RFattSETTING accordingly.
   2. For the FIGS. 3-5 Systems

The FIGS. 3-5 systems each use substantially similar calculations and display of data to the user as for FIG. 2 but the control variables are measured internally. This is the (common) calculation for FIGS. 3-5:

Calculate OMI per analog channel:
mANALOG=mbc*Sqrt[(6/Be)(80+33/4)/(Nanalog+Nbc256/10\hat{ }(x/10)+Nbc64/10\hat{ }(y/10)]
Calculate optical power and modulation index of the Narrowcast transmitter 32:
mNC256=mfactory*Sqrt[(6/Be) 8/(Nnc256+Nnc64/10\hat{ }((y−x)/10))]
Then the power ratio of Narrowcast/Broadcast=10 Log[mANALOG/mNC256 Sqrt[10\hat{ }(x/10)]]
The digital controller 68 then sets the optical attenuator 72 according to:
OptAtt=10 Log[mANALOG/mNC256 Sqrt[10\hat{ }(x/10)]]+Pncfactory−Pbc−LncWDM+LbcWDM
The digital controller board 68 then adjusts the value of RF attenuator 20 from the value of RFattFACTORY to
RFattSETTING=Fl=−20*log[mANALOG/mNC256]+Rfattfactory
The digital controller board 68 then monitors the changes made to the following parameters by the user:
NncQAM, Be, Nnc256, Nnc64, and adjusts the value of RFattSETTING accordingly.

3. Parameters for the FIG. 3 System

For FIG. 3 the operating parameters are:

| | | | | Common value |
|---|---|---|---|---|
| | | | | for entire |
| | | | set at | Broadcast |
| | variable | units | Factory? | region |
| INPUT VALUES | | | | |
| Input for Edge QAM 14 | | | | |
| # of RF channels (e.g. 1-30) | NncQAM | | NO | NO |
| bandwidth of RF channels (e.g. 6 or 8 MHz) | Be | MHz | NO | NO |
| # of RF channels with 256-QAM modulation | Nnc256 | | NO | NO |
| # of RF channels with 64-QAM modulation | Nnc64 | | NO | NO |
| Input for Narrowcast Transmitter 32 | | | | |
| Optimum optical modulation index for 8 | mfactory | | YES | NO |
| channel loading (set at factory) with 8 RF | | | | |
| QAM channels input channels | | | | |
| RF attenuator setting for such condition | RFattFACTORY | dB | YES | NO |
| (set at Factory) | | | | |
| Output power (set at factory) | Pncfactory | dBm | YES | NO |
| Input for Broadcast transmitter 42 | | | | |
| # of analog channels | Nanalog | | NO | YES |
| # of 256-QAM ch x dB below analog | Nbc256 | | NO | YES |
| | x | dB | NO | YES |
| # of 64-QAM ch y dB below analog | Nbc64 | | NO | YES |
| | y | dB | NO | YES |
| assumed OMI of transmitter = 3.6% | mbc | | default set | YES |
| | | | at 3.6% | |
| Optical measurement | | | | |
| Input optical power of broadcast wavelength | Pbc | | NO | NO |
| Insertion loss of WDM for Narrowcast | LncWDM | | NO | NO |
| wavelength | | | | |
| Insertion loss of WDM for Broadcast | LbCWDM | | NO | NO |
| wavelength | | | | |
| OUTPUT VALUES | | | | |
| adjustment for Ratt* | RfattSETTING | dB | Used for | |
| | | | internal | |
| | | | adjustment | |
| | | | or RF | |
| | | | attenuator | |
| Optical attenuation for NC** | Opt Att | dB | Given to | |
| | | | operator | |

4. Parameters for the FIG. 4 System

For FIG. 4 the operating parameters are:

| | | | | Common value |
|---|---|---|---|---|
| | | | | for entire |
| | | | set at | Broadcast |
| | variable | units | Factory? | region |
| INPUT VALUES | | | | |
| Input for Edge QAM 14 | | | | |
| # of RF channels (e.g. 1-30) | NncQAM | | NO | NO |
| bandwidth of RF channels (e.g. 6 or 8 MHz) | Be | MHz | NO | NO |
| # of RF channels with 256-QAM modulation | Nnc256 | | NO | NO |
| # of RF channels with 64-QAM modulation | Nnc64 | | NO | NO |
| Input for Narrowcast Transmitter 32 | | | | |
| Optimum optical modulation index for 8 | mfactory | | YES | NO |
| channel loading (set at factory) with 8 RF | | | | |
| QAM channels input channels | | | | |
| RF attenuator setting for such condition. | RFattFACTORY | dB | YES | NO |
| (set at Factory) | | | | |
| Output power (set at factory) | Pncfactory | dBm | YES | NO |
| Insertion loss of WDM for Narrowcast | LncWDM | | YES | NO |
| wavelength | | | | |
| Insertion loss of WDM for Broadcast | LbcWDM | | YES | NO |
| wavelength | | | | |
| Input for Broadcast transmitter 42 | | | | |
| # of analog channels | Nanalog | | NO | YES |
| # of 256-QAM ch x dB below analog | Nbc256 | | NO | YES |
| | x | dB | NO | YES |
| # of 64-QAM ch y dB below analog | Nbc64 | | NO | YES |
| | y | dB | NO | YES |
| assumed OMI of transmitter = 3.6% | mbc | | default set | YES |
| | | | at 3.6% | |
| Optical measurement | | | | |
| Input optical power of broadcast wavelength | Pbc | | NO | NO |
| OUTPUT VALUES | | | | |
| adjustment for Ratt* | RFattSETTING | dB | Used for | |
| | | | internal | |
| | | | adjustment | |
| | | | of RF | |
| | | | attenuator | |
| optical attenuation for NC** | Opt Att | dB | Used for | |
| | | | internal | |
| | | | adjustment | |
| | | | of variable | |
| | | | optical | |
| | | | attenuator | |

5. Parameters for the FIG. 5 System

For FIG. 5 the operating parameters are:

| | | | | Common value |
|---|---|---|---|---|
| | | | | for entire |
| | | | set at | Broadcast |
| | variable | units | Factory? | region |
| INPUT VALUES | | | | |
| Input for Edge QAM 14 | | | | |
| # of RF channels (e.g. 1-30) | NncQAM | | NO | NO |
| bandwidth of RF channels (e.g. 6 or 8 MHz) | Be | MHz | NO | NO |
| # of RF channels with 256-QAM modulation | Nnc256 | | NO | NO |
| # of RF channels with 64-QAM modulation | Nnc64 | | NO | NO |
| Input for Narrowcast Transmitter 32 | | | | |
| Optimum optical modulation index for 8 | mfactory | | YES | NO |
| channel loading (set at factory) with 8 RF | | | | |
| QAM channels input channels | | | | |
| RF attenuator setting for such condition. | RFattFACTORY | dB | YES | NO |
| (set at factory) | | | | |
| Output power (set at factory) | Pncfactory | dBm | YES | NO |
| Insertion loss of WDM for Narrowcast | LncWDM | | YES | NO |
| wavelength | | | | |
| Insertion loss of WDM for Broadcast | LbcWDM | | YES | NO |
| wavelength | | | | |
| Input for Broadcast transmitter 42 | | | | |
| # of analog channels | Nanalog | | NO | YES |
| # of 256-QAM ch x dB below analog | Nbc256 | | NO | YES |
| | x | dB | NO | YES |
| # of 64-QAM ch y dB below analog | Nbc64 | | NO | YES |
| | y | dB | NO | YES |
| assumed OMI of transmitter = 3.6% | mbc | | default set | YES |
| | | | at 3.6% | |
| Optical measurement | | | | |
| Input optical power of broadcast wavelength | Pbc | | NO | NO |
| OUTPUT VALUES | | | | |
| adjustment for Ratt* | RfattSETTING | dB | Used for | |
| | | | internal | |
| | | | adjustment | |
| | | | of RF | |
| | | | attenuator | |
| Optical attenuation for NC** | Opt Att | dB | Used for | |
| | | | internal | |
| | | | adjustment | |
| | | | of variable | |
| | | | optical | |
| | | | attenuator | |

6. For the FIG. 6 System

For the FIG. 6 system the parameters are:

| | | | | Common value |
|---|---|---|---|---|
| | | | | for entire |
| | | | set at | Broadcast |
| | variable | units | Factory? | region |
| INPUT VALUES | | | | |
| Input for Edge QAM 14 | | | | |
| # of RF channels (e.g. 1-30) | NncQAM | | NO | NO |
| bandwidth of RF channels (e.g. 6 or 8 MHz) | Be | MHz | NO | NO |
| # of RF channels with 256-QAM modulation | Nnc256 | | NO | NO |
| # of RF channels with 64-QAM modulation | Nnc64 | | NO | NO |
| Reference 256 QAM broadcast channel | ChBC | MHz | NO | YES |
| frequency | | | | |
| Reference 256 QAM narrowcast channel | ChNC | MHz | NO | NO |
| frequency | | | | |
| Input for Narrowcast Transmitter 32 | | | | |
| Optimum optical modulation index for 8 | mfactory | | YES | NO |
| channel loading (set at factory) with 8 RF | | | | |
| QAM channels input channels | | | | |
| RF attenuator setting for such condition. | RFattFACTORY | dB | YES | NO |
| (set at factory) | | | | |
| Output power (set at factory) | Pncfactory | dBm | YES | NO |
| Insertion loss of WDM for Narrowcast | LncWDM | | YES | NO |
| wavelength | | | | |
| Insertion loss of WDM for Broadcast | LbcWDM | | YES | NO |
| wavelength | | | | |
| Input for Broadcast transmitter 42 | | | | |
| # of analog channels | Nanalog | | NO | YES |
| # of 256-QAM ch x dB below analog | Nbc256 | | NO | YES |
| | x | dB | NO | YES |
| # of 64-QAM ch y dB below analog | Nbc64 | | NO | YES |
| | y | dB | NO | YES |
| assumed OMI of transmitter = 3.6% | mbc | | default set | YES |
| | | | at 3.6% | |
| Optical measurement | | | | |
| Input optical power of broadcast wavelength | Pbc | | NO | NO |
| RF measurement made within the device | RF ratio | | NO | NO |
| OUTPUT VALUES | | | | |
| adjustment for Ratt* | RFattSETTING | dB | Used for | |
| | | | internal | |
| | | | adjustment | |
| | | | of RF | |
| | | | attenuator | |
| Optical attenuation for NC** | Opt Att | dB | Used for | |
| | | | internal | |
| | | | adjustment | |
| | | | of variable | |
| | | | optical | |
| | | | attenuator | |

The associated calculations for FIG. 6 are:

Calculate OMI per analog channel:
mANALOG=mbc*Sqrt[(6/Be)(80+33/4)/(Nanalog+Nbc256/10\hat{ }(x/10)+Nbc64/10\hat{ }(y/10)]
Calculate optical power and modulation index of the Narrowcast transmitter 32:
mNC256=mfactory*Sqrt[(6/Be)8/(Nnc256+Nnc64/10\hat{ }((y−x)/10))]
Then the power ratio of Narrowcast/Broadcast=10 Log[mANALOG/mNC256 Sqrt[10\hat{ }(x/10)]]
The digital controller 68 provides a similar display of data to the user as for FIGS. 3-5 and then sets the optical attenuator 72 according to
OptAtt=10 Log[mANALOG/mNC256 Sqrt[10\hat{ }(x/10)]]+Pncfactory−Pbc−LncWDM+LbcWDM
The digital controller 68 then adjusts the value of RF attenuator 20 from the value of RFattFACTORY to
RFattSETTING=−20*log[mANALOG/mNC256]+Rfattfactory
After RFattSETTING is set, the apparatus measures the RF power at RF frequencies ChBC and ChNC. Controller 68 then implements a conventional control loop (see FIG. 7) to adjust the values of RFattSETTING and OptAtt in order to make RF power at both channels equivalent, and operates this loop until there is a change (see FIG. 8 “stop” step) in one of the user inputed values:
NncQAM, Be, Nnc256, Nnc64.

It is to be understood that the controller 68 may include any one of a number of well known microprocessors/microcontrollers with suitable internal/external memory of the type commercially available. Programming controller 68 in light of this disclosure to carry out the above described calculations and control and display functions is easily accomplished by one of ordinary skill in the art. The nature of the programming language, etc. is dependent upon the type of microprocessor/microcontroller employed. Moreover, controller 68 need not include a standalone microcontroller/microprocessor, but the controller may be incorporated in some other device or circuitry so long as the requisite intelligence as disclosed here is provided by same.

This disclosure is illustrative and not limiting; further modifications will be apparent to one skilled in the art in light of this disclosure and are intended to fall within the scope of the appended claims.

1. Apparatus comprising:
an input port for receiving a digital electrical or optical signal;
a modulator having an input terminal coupled to the input port and providing on its output terminal a radio frequency signal;
an optical transmitter having an input terminal coupled to receive the radio frequency signal from the modulator and providing on its output terminal an optical signal; and
a controller coupled to a control port of the modulator and to a control port of the optical transmitter, and having a user interface, thereby to control jointly the modulator and the optical transmitter.

2. The apparatus of claim 1, wherein the modulator is adapted to receive one of an Ethernet or an ASI compliant digital electrical or optical signal.

3. The apparatus of claim 1, wherein the modulator provides a quadrature amplitude modulated radio frequency signal converted onto a radio frequency carrier.

4. The apparatus of claim 1, wherein a user enters as data to the controller at least one of a radio frequency power level, a number of radio frequency channels, a bandwidth of at least one radio frequency channel, and a type of modulation of the modulator.

5. The apparatus of claim 1, wherein the user interface is SNMP (simple network management protocol) compliant.

6. The apparatus of claim 1, wherein the controller determines at least a radio frequency attenuation or an optical power attenuation of the optical transmitter.

7. The apparatus of claim 1, wherein the optical transmitter is a narrowcast transmitter.

8. The apparatus of claim 1, wherein the optical transmitter outputs an optical signal having substantially a single wavelength.

9. The apparatus of claim 1, wherein the controller receives at least one parameter from the user interface relating to operation of one of the modulator and optical transmitter, and determines at least one parameter relating to operation of the other of the modulator and optical transmitter.

10. The apparatus of claim 1, further comprising a variable radio frequency attenuator coupled between the modulator and the optical transmitter.

11. The apparatus of claim 1, wherein the controller determines at least one of a radio frequency attenuation, an optical attenuation, and a transmission power of the optical transmitter.

12. The apparatus of claim 10, wherein the controller controls the radio frequency attenuator.

13. The apparatus of claim 12, wherein the controller receives at least one command from the user interface and determines a setting of the radio frequency attenuator.

14. The apparatus of claim 10, further comprising a circuit coupled to the output terminal of the optical transmitter thereby to measure a ratio of power of a broadcast portion and a narrowcast portion of the optical signal.

15. The apparatus of claim 14, wherein the controller controls the radio frequency attenuator and an attenuation associated with the optical signal using the measured ratio.

16. A method of operating an apparatus coupled to receive a digital electrical or optical signal and to output an optical signal modulated by the digital electrical signal, comprising the acts of:
providing a single user interface for the apparatus;
accepting commands at the user interface; and
setting parameters for operation of the apparatus from the commands.

17. The method of claim 16, wherein the digital electrical or optical signal is one of an Ethernet or an ASI compliant signal.

18. The method of claim 16, wherein the optical signal is quadrature amplitude modulated.

19. The method of claim 16, wherein the commands specify at least one of a radio frequency power level, a number of radio frequency channels, a bandwidth of at least one radio frequency channel, and a type of modulation.

20. The method of claim 16, wherein the user interface is SNMP (simple network management protocol) compliant.

21. The method of claim 16, wherein the parameters include at least a radio frequency attenuation or an optical output power attenuation of the apparatus.

22. The method of claim 16, the optical signal having substantially a single wavelength.

23. The method of claim 16, the apparatus performing radio frequency modulating and optical transmitting of the digital electrical signal, wherein the user interface receives commands relating to one of the modulating and optical transmitting and sets at least one parameter relating to the other of the modulating and optical transmitting.

24. The method of claim 16, further comprising the act of variably attenuating an electrical signal in the apparatus.

25. The method of claim 21, wherein the act of setting parameters includes setting a value for the radio frequency attenuation or the optical output power attenuation.

26. The method of claim 16, further comprising the act of measuring a ratio of power of a broadcast portion and a narrowcast portion of the optical signal.

27. The method of claim 26, further comprising setting the parameters using the measured ratio.
